(19) United States
(12) Patent Application Publication
(10) Pub. No.: US 2018/0263727 A1
(43) Pub. Date: Sep. 20, 2018

(54) Surgical Guide and Associated Process for Dental Implants

(71) Applicant: Coredent Advancements, LLC, Gainesville, FL (US)

(72) Inventor: John Pellerito, Keystone Heights, FL (US)

(73) Assignee: Coredent Advancements, LLC, Gainesville, FL (US)

(21) Appl. No.: 15/922,907

(22) Filed: Mar. 15, 2018

Related U.S. Application Data
(60) Provisional application No. 62/471,480, filed on Mar. 15, 2017.

(51) Int. Cl. A61C 1/08; A61C 8/00; A61C 13/00

(52) U.S. Cl. CPC A61C 1/084; A61C 13/34; A61C 13/0004; A61C 8/0089

(57) ABSTRACT

The present invention discloses a precise and practical surgical guide system and process for dental surgical implants. According to some aspects, the system implements a reference point throughout the design and procedure to provide one or more guides for a specific part of the procedure. In some embodiments, the digital and physical data utilized in the design and planning, and production of the guide system may be implemented in virtual reality and/or augmented reality systems.

### CROSS-REFERENCE TO RELATED APPLICATION(S)

This patent application claims priority to and is a non-provisional filing of U.S. provisional patent application Ser. No. 62/471,480, filed Mar. 15, 2017. titled “Surgical Guide and Associated Process for Dental Implants”, the entire content which is hereby incorporated herein by reference in its entirety.

### FIELD OF THE INVENTION

This invention describes a surgical guide for dental implants, and more specifically, a system and associated process for developing and implementing improved patient specific surgical guides that leverage from computer aided design and computer aided manufacturing (CAD/CAM).

### BACKGROUND OF THE INVENTION

Many aspects of digital advancements in the professional field of dentistry have plateaued. A need exists for innovation that implements computer aided design and computer aided manufacturing (CAD/CAM) in order to effectively integrate data from different sources, which consequently cornea in different forms, while maintaining required levels of precision and accounting for highly complex surgical environments.

Precision is of upmost importance in most dental implant procedures. All elements of the process and/or workflow must reach an equal degree of accuracy. For example, even a great plan for oral rehabilitation, it not designed and executed properly, is jeopardized with the possibility of major setbacks, costly new beginnings, loss of case momentum, and a decrease in patient and practitioner confidence.

In particular to dental implant surgeries, the challenges that must be accounted for are many and although some of the digital processes and digital systems have continued to improve, various improvements are still desired for effective and minimally invasive surgical implants. For example, systems and processes that account for:

The need for continuous and less restricted access into the mouth of a patient during an implant procedure. In some existing systems, for example, the surgical guides are large and restricting in order to provide the required strength without flex. This bulk is due to the less than optimal materials currently used (acrylics and resins) and manufacturing processes (3D printing and investment casting). The consequences of this often results in an increase in trauma and risk to the patent;

Also desired are systems that don't interfere with air flow during the procedure, inhibiting breathing of the patient, and are designed for confined spaces but yet are sufficiently rigid and enable a dynamic environment (mobility of jaw and tongue) and account for fluid management (biological and irrigation). Strength and size also restricts the ability arid desire to remove the devices during surgery for any reason. For example, inhibiting visual confirmations of accuracy, airway complication with fluids, patient heath issues that would lead to aborting surgery (surgical devises and protocol may not be re-implemented due to surgical postponement), time added to the sedation, and confidence in the ability to replace the devises properly in the correct location;

Materials used and their post processing protocols are also a major concern with surgical post-operative complications. Most dental implant procedures involve some form of cutting, drilling, grinding, or abrading during surgery. This can inevitably occur on the devices (surgical guides) that are directing or controlling these processes. While there is little to no studies showing the effects of debris left in the surgical dental field and its effect on surgical success of dental implants procedures, it is known that any foreign body in tissue can create inflammation and/or compromise the healing of such; and

Data collection protocol and the diversity in quality and calibration, of multiple scanner manufactures, creates its own challenges. Current designs and accuracy are based on the ability for software to render or create a digital object that represents the patent's specific anatomy (bone, teeth, etc.). In other words, the same patient scanned with two different scan manufactures may render different results. Therefore, surgical design based on digital data alone may start with some degree of uncertainty. The limited ability to accurately integrate data from multiple sources and forms (e.g., from different CT scanner manufactures), due to all of the aforementioned variables, have negatively impacted in the recently developed systems and processes.

Accordingly, in order to overcome at least the aforementioned limitations and design inefficiencies, improved dental implant systems and associated processes are highly desired.

### SUMMARY OF THE INVENTION

The foregoing needs are met, to a great extent, by the present invention, wherein in one aspect the system and associated process is focused on providing a precise and practical system for the surgeon or practitioner while remaining relatively innocuous to the patient during a surgical procedure. According to one aspect, this can be enabled by representing a digital and anatomical base reference point or origin for all of the digital workup and the procedure.

According to some aspects, the most critical point in the workflow may be the transition from digital (CAD/CAM) to analog (surgical treatment), leaving the controlled environment to a commonly unpredictable one. By focusing on a reference point, an increase of the predictability for surgical success and a superior experience for the doctor and their patient can result.

In accordance with additional aspects, a dental surgical guide system includes a base guide generated using a digital scan of a patient's mouth and at least one anatomical feature on an impression of the patient's mouth, wherein the base guide includes at least one relocated reference point for a retention appliance; and a reference guide configured to be positioned onto one or more of the at least one relocated reference point of the retention appliance, wherein the reference guide enables a dental practitioner to drill in at least one reference point. In some embodiments, one or both of the base guide and the reference guide may be removable during the surgical procedure. The materials of the base guide and the reference guide may have different rigidity and/or other material characteristics. For example, at least one of the base guide, the retention appliance, and the reference guide include antimicrobial surface nano-patterns. In yet additional aspects, at least one other reference guide that is also configured to be positioned onto one or more of the at least one relocated reference point of the retention appliance may be included.

In yet additional aspects of the disclosure, a process for a surgical dental implant procedure is disclosed. The process including performing a diagnostic impression of a patient's mouth; performing a digital scan of anatomical features of a patient's mouth; generating treatment guides using both the diagnostic impression and the digital scan, wherein the treatment guides include a relocated reference point; and performing dental surgical treatment using the treatment guides. In some applications, the process may additionally include generating a digital file including the digital scan and a digital model of the treatment guides for an augmented reality application or a virtual reality application.

There has thus been outlined, rather broadly, certain aspects of the disclosure in order that the detailed description thereof herein may be better understood, and in order that the present contribution to the art may be better appreciated. There are, of course, additional aspects of the invention that will be described below and which will form the subject matter of the claims appended hereto.

In this respect, before explaining at least one aspect of the invention in detail, it is to be understood that the invention is not limited in its application to the details of construction and to the arrangements of the components set forth in the following description or illustrated in the drawings. The invention is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other methods and systems for carrying out the several purposes of the invention. It is important, therefore, that the claims be regarded as including such equivalent constructions insofar as they do not depart from the spirit and scope of the invention.

### BRIEF DESCRIPTION OF THE DRAWINGS

The foregoing and other features and advantages of the invention will be apparent from the following, more particular description of exemplary embodiments of the invention, as illustrated in the accompanying drawings.

FIG. 1 is as representation of an exemplary base guide according to aspects of the disclosure that can be used to relocate the retention appliances;

FIG. 2 is a representation of exemplary retention appliances that can be implemented according to aspects of the disclosure;

FIG. 3 is a representation of an exemplary drill guide that can be integrated with the retention appliances to provide a new reference point for an implant; and

FIG. 4 is a flowchart diagram 400 illustrating process steps that may be implemented during dental surgery and implementing a reference guide in accordance with aspects of the disclosure.

### DETAILED DESCRIPTION OF THE INVENTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made without departing from the scope and spirit of the present disclosure.

In accordance with some aspects, an objective to the solution and process can be to relocate stable and predictable new reference point(s), based on known and tangible anatomy, not completely relying on computer renderings. This new reference point(s) can be designed specifically to not have a negative impact on the space and other challenges mentioned above.

According to another aspect of the disclosure, the process of relocating the reference point can enable receiving a set of surgical guides. From the set, each guide may have its own specific use at one or more point during the dental surgery. These guides can enable a snap/slide to the new reference point by itself for a specific job, eliminating the known “Stackable” guide protocols that currently exist. Each guide can be removed completely from the surgical site for evaluation or an emergency issue and then replaced quickly or at a later date in time with confidence to its proper position.

The new reference point can be accomplished using guided surgery, positioned on known anatomy in order to surgically place a form of retention appliance, minimal in size (lateral anchor screws as an example). This new reference may also be representative of the new base in order to receive any template needed within the treatment.

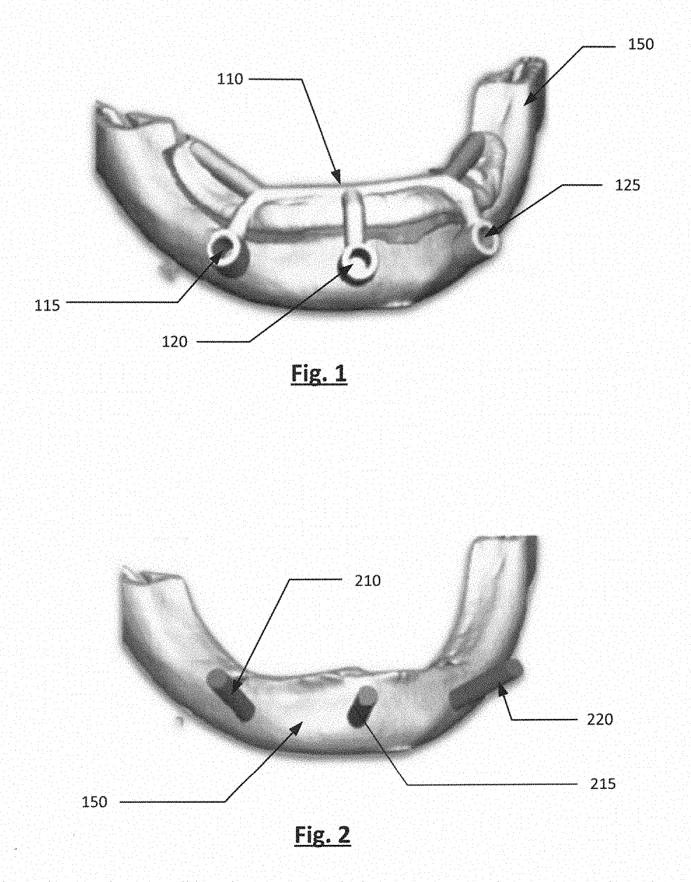

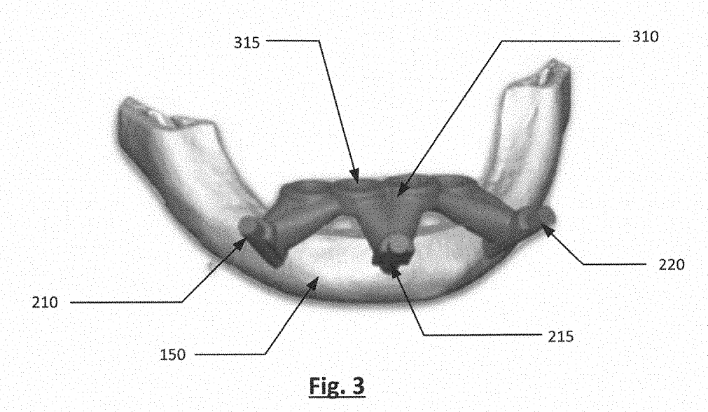

Referring to FIGS. 1 and 2, an exemplary base guide 110 and an exemplary retention appliances 210, 215, 220 that can be implemented using anatomical features 150 according to aspects of the disclosure are depicted. The base guide 110 may include relocated reference point(s) 115, 120 125, as previously discussed. Moreover, the base guide 110 and retention appliance 210, 215, 220 may be integrated with one or more appliances or reference guide (e.g., as shown in FIG. 3) for different aspects and part of the procedures. FIG. 3, for example, depicts a surgical drill guide 310 that can be integrated with the retention appliances 210, 215, 220 to provide at least one drilling reference point 315 for an implant. Moreover, these appliances 210, 215, 220, for example, can be of a standard that would allow them to remain in place for the duration of treatment and be used in any way (support of intermediate prothesis) to prevent irritation o the healing surgical site. In some procedures, for example, at a point in time when needed, these appliances 210, 215, 220 can then be removed with very little, if any at all, trauma. Materials of each component can vary depending on the required strength, flexibility, sterile nature, cost, and the such. In some embodiments, for example, the surfaces of one or more components may be treated with antimicrobial nano-patterns that can prevent infections and/or debris from adhering thereto.

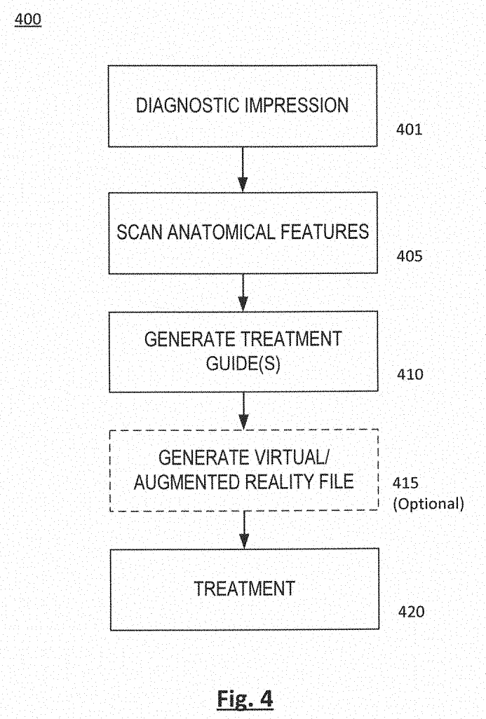

Referring now to FIG. 4, a flowchart diagram 400 illustrating process steps that may be implemented during dental surgery and implementing a reference guide in accordance with aspects of the disclosure is shown. In particular, describing the diagnostic impression 401, CT scan of anatomical features 405, treatment guide generation 410, an augmented reality file 415 (optionally) to assist in the procedure, and treatment 420 as allows.

### Diagnostic Impression

At 401, according to some aspects, the patient nay include the patient workup in which a full arch impression of the proposed jaw with only a bite registration to show the opposing dentition is performed. This may be of a polyvinyl impression material, and if alginate needs to be used, pour up with white stone is discouraged to prevent it from interfering with the scan. Open format intraoral scans with .SIL extension can be transmitted to the lab. Using the impression, the diagnostic workup may be created. At this point, models may be scanned and files can be assembled according to the treatment plan which may be discussed using a virtual wax up. The RDM may then be fabricated and sent to the requested facility prior to consultation with implant specialist.

### CT Scan

At 405, the patient's mouth may be scanned using a Key-Bite, E-Bite, or Custom Bite. For scanning, the patient should be positioned in a scanner so that the RDM can be as parallel as possible to the axial slices of CT so the markers are not consumed by the scatter caused by fixed restorative work. All restraints provided by the scanner are recommended to minimize patient movement ensuring clean data for 3D rendering. Following the scan, the RDM may be discarded, and the raw dicom files are uploaded to Pro Precision Guides for planning. In some embodiments, using custom Radiographic Data Markers (RDM) for each patient can significantly eliminate the need to duplicate or alter existing prostheses, and may enable thorough scans in one simple step.

### Treatment Planning

At 410, the CT Scan, can be imported into implant treatment software where each guide may be specifically designed for the individual patient and implant system, and then sent to a 3D printer or molded. Precision may be maximized by employing a digital workflow. Models can include, for example, digitized using 5-axis triangulating lasers, and open architecture CAD/CAM software allows complete design and fabrication freedom.

### Virtual/Augmented Reality Digital File

At 415, optionally, the guides, tools, components, scans, and digital data may additionally be used to generate a virtual reality digital file to be used with systems to simulate the procedure and/or augmented reality systems to provide step by step guidance to the surgeon or practitioner.

### Treatment

At 415, during the procedure, the components can be implemented to enable the practitioner to accomplish the needs of the patient while allowing some flexibility according to conditions that can arise during the surgery.

### CONCLUSION

A number of embodiments of the present invention have been described. While this specification contains many specific implementation details, these should not be construed as limitations on the scope of the invention(s) or of what may be claimed, but rather as descriptions of features/aspects specific to particular apparatus embodiments of the present invention and in the dental surgical field.

1. A dental, surgical guide system comprising:
a base guide generated using a digital scan of a patient's mouth and at least one anatomical feature on an impression of the patient's mouth, wherein the base guide includes at least one relocated reference point for a retention appliance; and
a reference guide configured to be positioned onto one or more of the at least one relocated reference point of the retention appliance, wherein the reference guide enables a dental practitioner to drill in at least one reference point.

2. The dental surgical guide system of claim 1, wherein one or both of the base guide and the reference guide is removable during the surgical procedure.

3. The dental surgical guide system of claim 1, wherein the materials of the base guide and the reference guide have different rigidity.

4. The dental surgical guide system of claim 1, additionally comprising:
at least one other reference guide that is also configured to be positioned onto one or more of the at least one relocated reference point of the retention appliance.

5. The dental surgical guide system of claim 1, wherein at least one of the base guide, the retention appliance, and the reference guide include antimicrobial surface nano-patterns.

6. A process for a surgical dental implant procedure, the process comprising:
performing a diagnostic impression of a patient's mouth;
performing a digital scan of anatomical features of a patient's mouth;
generating treatment guides using both the diagnostic impression and the digital scan, wherein the treatment guides include a relocated reference point; and
performing dental surgical treatment using the treatment guides.

7. The process of claim 6, additionally comprising:
generating digital file including the digital scan and a digital model of the treatment guides for an augmented reality application.

8. The process of claim 6, additionally comprising:
generating a digital file including the digital scan and a digital model of the treatment guides for a virtual reality application.
